(19) United States
(12) Patent Application Publication
(10) Pub. No.: US 2017/0162349 A1
(43) Pub. Date: Jun. 8, 2017

(54) SELF-BLAST CIRCUIT BREAKER USING THE TWO-PHASE STATE OF A GAS TO IMPROVE THE CUT-OFF PROPERTIES

(71) Applicant: ALSTOM TECHNOLOGY LTD., Baden (CH)

(72) Inventors: Alain GIRODET, Chassieu (FR); François BIQUEZ, Pugny-Chatenod (FR); Yannick KIEFFEL, Saint-Jean-de-Bournay (FR)

(21) Appl. No.: 15/324,439

(22) PCT Filed: Jul. 8, 2015
(86) PCT No.: PCT/EP2015/065570

§ 371 Date: Jan. 6, 2017

(30) Foreign Application Priority Data
Jul. 8, 2014 (FR) 14 56584

(51) Int. Cl. H01H 33/75; C01B 13/02; H01H 33/74; C01B 21/02; H01H 33/70; H01H 33/84

(52) U.S. Cl. CPC H01H 33/75; H01H 33/7015; H01H 33/84; H01H 33/74; C01B 21/02; C01B 13/02; C01B 31/20

(57) ABSTRACT

A breaking chamber (1) for a medium- or high-voltage circuit breaker extending along a longitudinal axis (XX′) and comprising: a pair of arcing contact (4, 5), at least one (5) of which is movable along the longitudinal axis (XX′); an arc-blast nozzle (6); a blast chamber (7), having a volume V2 that is constant and that opens out inside the blast nozzle; a compression chamber (8), arranged substantially behind the blast chamber, and structures (73, 81) for putting the internal volume of the compression chamber (8) into communication with the internal volume of the blast chamber (7); and structures (14, 15, 50), disposed substantially behind the compression chamber (8), in order to deliver liquid, either into the compression chamber (8), or directly into the blast chamber (7).

### TECHNICAL FIELD AND STATE OF THE PRIOR ART

The invention relates to the breaking chambers of high-voltage circuit breakers operating in the range 72.5 kilovolts (kV) to 1200 kV using air-insulated switchgear (AIS), gas-insulated switchgear (GIS), or dead tank technology.

Breaking chambers have used SF₆ as an arc-extinction gas for 40 years. Firstly, compared to gases such as air, nitrogen, or CO₂, SF₆ has very good dielectric properties and, secondly, its electronegativity properties mean that the medium ionized by the energy of the electric arc quickly gains good insulating properties due to the free electrons binding to the SF₆ ions.

The present invention relates to a device that makes it possible to inject a liquid into the arcing zone during separation of the contacts, with vaporization of the liquid assisting in interrupting the current.

In the past, breaking in liquid was developed for the entire generation of oil circuit breakers. It was then abandoned in favor of SF₆ gas because of its superior performance.

International application WO 2013/087688 is known that describes using a conventional circuit breaker chamber, and adding volumes containing a liquid of the organofluorine type, some of which is ejected into the thermal volume, or close to the contacts, by a piston system during operation of the equipment. The liquids proposed in that document are essentially from the fluoroketone family.

The device proposed in that document does not make it possible to control the amount of liquid injected in accurate manner. In fact, only a few milliliters (mL) of liquid are required, and on vaporizing they create a large amount of gas. An amount of liquid that is too variable, when injected into the circuit breaking zone, may produce a rise in pressure that is too great and destroy the elements of the breaking zone, e.g. the nozzle.

In that document, the tank of liquid is placed around the main contact of the circuit breaker.

Temperature rises due to passing current may reach 65° C., i.e. a maximum temperature of 105° C. Under those conditions, there is a risk of complete vaporization of the liquid or of excess pressure to be evacuated in the breaking chamber. Some or all of the liquid re-condensing at the base of the equipment will have no beneficial effect on breaking.

That also leads to a reduction in the volume of liquid in the injection zone and drastically changes the amount of liquid injected by compressing the gas contained in the dead volume.

Other solutions are known, but they relate to circuit breakers using SF₆ only, for use at low temperatures.

In this context, French patent No. FR 2 602 088 is known in particular, which describes an SF₆ circuit breaker for applications at low temperature. Injection of liquid arises from the breaking gas liquefying when the temperature drops below its liquefaction temperature at the filling pressure. The circuit breaker is of the self-blast type, with injection taking place in the thermal volume.

Document U.S. Pat. No. 4,739,137 presents an SF₆ circuit breaker, also for low temperature application, in which liquid is injected by transferring some of the liquid condensed in a tank to the breaking zone, under the action of the opening movement of the breaking chamber.

Documents EP 0 204 180 and FR 2 585 875 present another method of injecting liquid into the breaking zone. They also relate to an application to SF₆ circuit breakers used for low temperatures, where some of the SF₆ gas condenses when the temperature drops below a certain value.

In addition, the use of gas mixtures using CO₂ as a carrier gas and a fluoroketone, a fluoro-oxirane, or a fluoronitrile as an additional gas have already shown their value due to the fact that their dielectric properties are close to those of SF₆.

However, the high liquefaction point, around 0° C., of those compounds limits the filling partial pressure to a value close to the value of the saturated vapor pressure at the minimum utilization temperature of the equipment (e.g. −25° C.), which leads to a small percentage of the fluorinated gas being introduced into the mixture (of the order of 4% to 7%). While the dielectric properties of those mixtures are close to 80% of the dielectric properties of SF₆, the properties during breaking in particular resemble those of the carrier gas, i.e. CO₂. Thus, obtaining properties during breaking that are comparable to those of SF₆ requires or would require increasing the pressure of the carrier gas, increasing the dimensions of the breaking chamber, and/or reducing performance on the interrupted current or on the nominal voltage.

The problem thus arises of providing a new device for injecting a liquid into the thermal zone of a breaking chamber of a circuit breaker.

Preferably, this new device should operate in a manner that is simpler than known devices, and should not present the above-mentioned drawbacks.

The problem also arises of finding a new liquid that is suitable for being injected into the thermal zone of a breaking chamber of a circuit breaker, without presenting the above-described problems.

Preferably, the injected liquid firstly presents good dielectric properties, close to those of SF₆, and secondly presents an environmental impact that is much lower than that of SF₆, in particular in terms of global warming potential (GWP).

### SUMMARY OF THE INVENTION

The invention aims to overcome these drawbacks.

The invention provides a breaking chamber for a medium- or high-voltage circuit breaker extending along a longitudinal axis (XX′) and comprising:
a pair of permanent contacts and a pair of arcing contacts, at least one of which is movable along the longitudinal axis (XX′) under the action of a drive member, the contacts separating during a current interruption;
an arc-blast nozzle that is secured to the stationary arcing contact;
a blast chamber, having a volume V2 that is constant and that opens out inside the blast nozzle;
a compression chamber, arranged substantially behind the blast chamber, parallel to the longitudinal axis XX′, and means for putting the internal volume of said compression chamber into communication with the internal volume of the blast chamber; and
means, disposed substantially behind the compression chamber, parallel to the longitudinal axis XX′, in order to deliver liquid, either to the compression chamber, or directly to the blast chamber.

The means, disposed substantially behind the compression chamber, parallel to the longitudinal axis XX′, in order to deliver liquid, either to the compression chamber, or directly to the blast chamber, are disposed inside a wall of a piece of movable equipment or of an assembly of movable means, connected at least to said at least one movable contact, or on the inside side of said wall. The inside side of said wall can be understood as being its side located on the same side as the contacts.

Going from the first chamber along the axis XX′, there can be found in succession: the compression chamber, disposed behind the first chamber, followed by the means for delivering liquid, behind the compression chamber.

Said means may comprise a third chamber and piston-forming means that are able to move inside said chamber under the action of a backwards movement of the movable equipment of said chamber.

Means may be provided in order to form a channel so as to inject a liquid present in said third chamber into the blast chamber. Said means, forming a channel, may further comprise check valve-forming means.

In a variant, the means, disposed substantially behind the compression chamber in order to deliver liquid, either to the compression chamber, or directly to the blast chamber, include liquid injector-forming means.

Control means for controlling said liquid injector-forming means may also be provided. Said control means may be connected to at least one sensor, e.g. comprising at least one sensor for sensing the relative position of the contacts, and/or a sensor for measuring a current value, and/or a sensor for measuring voltage in said chamber.

The movable equipment of the chamber may further comprise means for activating a rise in pressure in said injector-forming means.

Such a breaking chamber may comprise means forming a liquid accumulator in order to feed said injector-forming means.

Liquid-storing means may make it possible to feed said accumulator-forming means.

In a particular embodiment, the injector is a pump-injector.

The means forming at least one pump-injector may then be fed by a tank, connected to the injector-forming means without using an accumulator or a pump.

Means for activating the pump-injector may also be provided.

The invention may apply to a double motion chamber, having two movable contacts.

The invention also provides a method of operating a breaking chamber of the invention wherein said liquid is injected, either into the compression chamber, or directly into the blast chamber, during separation of the arcing contacts.

Consequently, depending on the embodiment of the invention, liquid-injection means may comprise either a system such as a tank combined with a piston that is moved by movement of the movable portion of the chamber, or else by a device of the injector type, e.g. controlled by electronic means taking readings of or measuring voltage and/or current and/or contact movement information, with the intention of injecting a certain amount of liquid at a certain instant.

A breaking chamber of the invention is usable at all operating temperatures, and not only at low temperatures.

The performance of a breaking chamber of the invention is improved by injecting liquid, either directly into the blast chamber, or via the compression chamber, the liquid being in this form whatever the operating temperature, including above 72° C., or even 105° C.

The invention therefore provides a breaking chamber, or a circuit breaker, that makes use of injection of a liquid into the compression volume or into the thermal volume in order to promote circuit breaking.

The injected liquid may comprise at least one fluorinated compound.

The term “fluorinated compound” relates to a carbon compound possibly including one or more heteroatom(s) in particular selected from an oxygen atom or a nitrogen atom, in which at least one hydrogen atom is substituted by a fluorine atom. The fluorinated compound usable in the context of the present invention may be a perfluorinated compound. The term “perfluorinated compound” refers to a compound, and in particular a fluorinated compound as defined above, having all of its hydrogen atoms substituted by fluorine atoms.

Advantageously, such a compound presents a boiling temperature at atmospheric pressure that is greater than ambient temperature. According to the conventionally accepted meaning, the term “atmospheric pressure” refers to a pressure of 1 atmosphere (atm) corresponding to a pressure of 760 millimeters of mercury (mm Hg) or to a pressure of 101.3 kilopascals (kPa). The term “ambient temperature” relates to a temperature lying in the range 18° C. to 24° C. In particular, the fluorinated compound typically has a boiling temperature at atmospheric pressure that is greater than 40° C., in particular greater than 60° C. and, more particularly, greater than 80° C.

Any fluorinated compound suitable for presenting such a boiling temperature is usable in the context of the present invention. Advantageously, such a compound is neither toxic, nor corrosive, nor flammable, and presents a GWP that is low relative to that of SF₆. The term “low GWP” refers to a GWP that is less than 8000, in particular less than 5000 and, more particularly, less than 2500. In addition, such a fluorinated compound typically presents dielectric strength that is greater, in the gaseous state, than that of SF₆.

Advantageously, said fluorinated compound is selected from the group constituted by fluoronitriles, fluorinated oxiranes, fluoroketones, and mixtures thereof.

Fluoronitriles suitable for use in the invention satisfy the general formula (I) below:

R¹—C(CN) (R²)—R³ (I)

in which:
R¹ and R³, are identical or different, and represent a fluorinated or perfluorinated alkyl group; and
R² represents a fluorine atom, a fluorinated or perfluorinated alkyl group, or a fluorinated or perfluorinated aryl group.

The term “alkyl group” refers to a linear, branched, or cyclic alkyl group, having 1 to 15 carbon atoms, and in particular 1 to 10 carbon atoms, and possibly having one or more simple or double unsaturated bonds.

In the context of the present invention, the term “aryl group” refers to an aromatic carbon structure, made up of one (or more) aromatic ring(s) each having 3 to 8 carbon atoms and in particular six carbon atoms, possibly mono- or poly-substituted, such as for example, by groups of alkyls having 1 to 6 carbon atoms.

Advantageously, a fluoronitrile used in the invention is a perfluorinated fluoronitrile having the general formula (I). In particular, for such a fluoronitrile, the group R² represents a fluorine atom.

Still more particularly, for such a fluoronitrile, the groups R⁴ and R³ are identical. In a variant of such a fluoronitrile, the groups R⁴ and R³ are different.

The fluorinated oxiranes suitable for use in the invention satisfy the general formula (II) below:

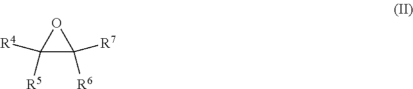

in which R⁴, R⁵, R⁶, and R⁷, identical or different, represent a fluorine atom, a fluorinated or perfluorinated alkyl group, in particular as described above, or a fluorinated or a perfluorinated aryl group, in particular as described above.

Advantageously, the fluorinated oxirane used in the invention is an oxirane having the general formula (II) and having at least four carbon atoms.

Advantageously, a fluorinated oxirane used in the present invention is a perfluorinated fluorinated oxirane having the general formula (II). In particular, for such a fluorinated oxirane, one, two, or three groups selected from R⁴, R⁵, R⁶, and R⁷ represent a fluorine atom.

By way of illustrative and non-limiting examples of such fluorinated oxiranes, mention may be made of the oxirane 2,2,3-trifluoro-3-(1,1,2,3,3-pentafluoroprop-2-enyl) having the formula C₅F₈O and CAS number 15453-08-4 and the oxirane 2,2,3-trifluoro-3-(1,1,2,2,3,4,4-heptafluoro-prop-3-en-1-yl)oxirane having formula C₆F₁₀O and CAS number 15453-10-8.

The fluoroketones suitable for use in the present invention satisfy the general formula (III):

R⁸—C(O)—R⁹ (III)

in which R⁸ and R⁹, identical or different, represent a fluorinated or perfluorinated alkyl group, in particular as described above, or a fluorinated or perfluorinated aryl group, in particular as described above.

Advantageously, the fluoroketone used in the invention is a fluoroketone having the general formula (III) and having at least six and in particular at least seven carbon atoms.

By way of illustrative and non-limiting examples of such fluorinated fluoroketones, mention may be made of the fluoroketones having six or seven carbon atoms as described in the international application WO 2013/087688.

In a breaking chamber of the invention, the dielectric strength in the equipment may be achieved by using an insulating gas or filling gas. Said filling gas may be SF₆ or, preferably, any other insulating gas having low environmental impact, i.e. any insulating gas used or envisaged for replacing SF₆.

By way of illustrative and non-limiting examples, such an insulating gas may comprise one (or more) elements selected from the group constituted by air and in particular dry air, nitrogen, oxygen, carbon dioxide, an inert gas and in particular argon, a fluoronitrile, a fluorinated oxirane, a fluoroketone, or mixtures thereof.

In a first embodiment, the insulating gas may be an insulating gas selected from the group constituted by air and in particular dry air, nitrogen, oxygen, carbon dioxide, an inert gas and in particular argon, or mixtures thereof.

In a second embodiment, the insulating gas may be a mixture (i) of a gas selected from the group constituted by air and in particular dry air, nitrogen, oxygen, carbon dioxide, an inert gas and in particular argon, or mixtures thereof, and (ii) of a gas selected from the group constituted by a fluoronitrile, a fluorinated oxirane, and a fluoroketone. Advantageously, in this embodiment, the injected liquid fluorinated compound and the second gas of said mixture belong to the same chemical family.

Thus, if the injected fluorinated compound is a fluoronitrile, the gas in the mixture will also be a fluoronitrile and in particular 2,3,3,3-tetrafluoro-2-trifluoromethyl propanenitrile or heptafluoroisobutyro-nitrile having formula CF₃—C(CN) (F)—CF₃ and CAS number: 42532-60-5.

In addition, if the injected fluorinated compound is a fluorinated oxirane, the gas in the mixture will also be a fluorinated oxirane and in particular 2,3-(difluoro-2,3-bis(trifluoromethyl)oxirane that satisfies the particular formula (IV):

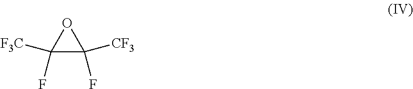 [SMILES: FC(F)(F)C1(F)OC1(F)C(F)(F)F]

In addition, if the injected fluorinated compound is a fluoroketone, the gas in the mixture will also be a fluoroketone and in particular a C4K and C5K fluoroketone as defined in international application WO 2012/038442.

### BRIEF DESCRIPTION OF THE DRAWINGS

Other advantages and characteristics of the invention can be seen better on reading the detailed description made in reference to the following figures, in which:

FIG. 1 shows a first embodiment of an breaking chamber of the invention in longitudinal section view, said chamber is provided with a tank-forming compartment for liquid that is to be injected into at least one of the other chambers;

FIG. 2 shows another embodiment of a breaking chamber of the invention in longitudinal section view, said chamber being provided with an injector, e.g. of the type used in spark-ignition engines, for injecting into the compression chamber;

FIG. 3 is a variant of FIG. 2, with means for injecting, from said injector, directly into the thermal volume;

FIG. 4 shows another embodiment of a breaking chamber of the invention in longitudinal section view, said chamber being provided with a pump-injector, activated by the movable equipment; and

FIG. 5 shows another embodiment of a breaking chamber of the invention in longitudinal section view, with double motion.

### DETAILED DESCRIPTION OF PARTICULAR EMBODIMENTS

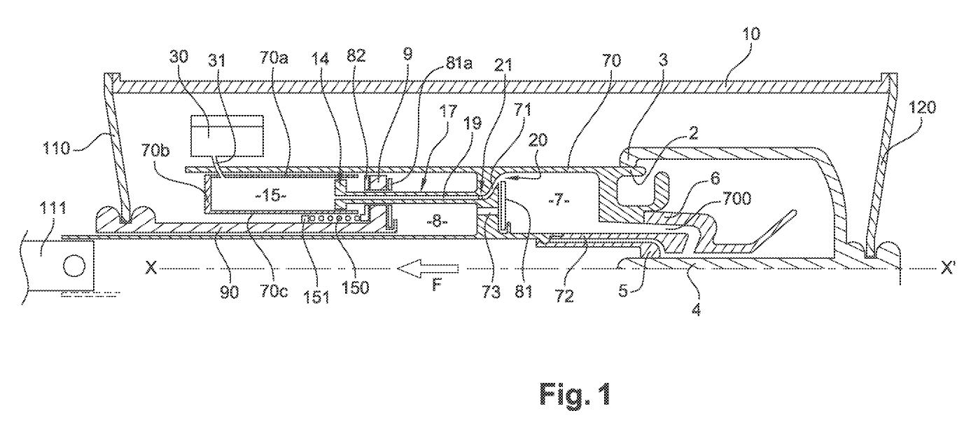

An example of a breaking chamber of the invention is shown in FIG. 1. It is a breaking chamber of the “self-blast” type.

The breaking chamber extends along a longitudinal axis XX′, that also constitutes an axis of revolution of the device and further comprises a casing 10, that in this example is a metal casing. This casing encloses a pair of permanent contacts 2, 3, one of which is stationary 3 and the other 2 is movable along the longitudinal axis XX′, under the action of an operating member (not shown).

The breaking chamber also includes a stationary arcing contact 4 that is mechanically connected to the permanent contact 3, and a movable arcing contact 5, said movable contact being connected to a movable assembly or piece of equipment 70, 71, or to movable means 70, 71. In an embodiment, the side wall of the movable equipment comprises a cylinder 70 sliding parallel to the axis XX′.

The movable equipment may be caused to move by means 111, e.g. a shaft, which means make it possible to exert a traction or thrust on said equipment, along the axis XX′.

Support-forming elements 110, 120 make it possible to mechanically connect together the stationary portion and the outer casing 10. The stationary portion of the device comprises the contacts 3, 4, the supports 110, 120, and the casing 10. For a metal casing 10, the supports 110, 120 are electrically insulating.

In a variant, the casing 10 is insulating. The stationary portion of the device is connected via flange-forming means, disposed at the end of the casing 10 and secured thereto. This embodiment is not shown in greater detail in the figures, but the invention may be applied thereto, and all other explanations given herein remain valid.

The casing 10 contains a gas, e.g. SF₆, but preferably another gas, or, in a variant, a gas containing mainly CO₂ or nitrogen. Still in a variant, this filling gas may have added thereto a small fraction (i.e. between 3% and 10% by volume relative to the total volume of the gas mixture) of 2,3,3,3-tetrafluoro-2-trifluoromethyl propanenitrile or of heptafluoroisobutyronitrile having formula CF₃—C(CN) (F)—CF₃ and CAS number 42532-60-5.

The stationary contact 4 is secured to the permanent stationary contact 3. The movable contact 5 is also movable along the longitudinal axis XX′ and is secured to the permanent movable contact 2.

In a variant, all the contacts are movable, the device then being a double motion chamber.

The arcing contacts 4, 5 are provided so as to separate from each other when current is interrupted, and the same applies to the permanent contacts 3 and 2.

The contacts 2, 3 separate before the contacts 4, 5. Preferably, the stroke in translation of the movable contact 5 is sufficiently long to interrupt current regardless of its magnitude and to obtain the dielectric strength of the circuit breaker.

An arc blast nozzle 6 is also provided that is secured to the movable arcing contact 5.

A first chamber or volume 7 referred to as a “blast” or “thermal” volume 7 is defined by the side wall of the movable equipment 70, by a wall 71 connected to said movable equipment 70 and directed substantially perpendicularly to the axis XX′, by the arc blast nozzle 6, and by a dielectric part 72 that fits the shape of the movable arcing contact 5. This chamber 7 defines a fixed volume V2, but that is brought in translation (as seen looking along arrow F) by the movable equipment assembly 70, during opening of the contacts. This volume opens out inside the blast nozzle 6 via a blast channel 700 (between the parts made of dielectric material 6 and 72), of small diameter in order to bring the blast gas into a zone, outside the chamber 7, where the arc is produced that forms between the arcing contacts during breaking.

The chamber 7 includes a valve 81 that comes to block the communication passage 73 when the pressure inside the volume 7 is greater than that inside the volume 8.

A second chamber or volume 8, referred to as a “compression” volume 8 is defined by the side wall of the movable equipment 70, by the wall 71, and by a wall 9 connected to the stationary portion of the device.

This wall 9 forms a piston that makes it possible to compress the volume V1 of this compression chamber. The volume V1 is therefore variable and opens out into the blast chamber 7 whenever the action of the piston 9 makes it possible to exceed a certain pressure, as described above.

The compression and blast chambers 8 and 7 are arranged substantially one behind the other parallel to the longitudinal axis XX′. They may both be defined in part by the inside surface of the side wall 70, which is cylindrical in one embodiment. They are separated by the wall 71, which is connected to said side wall.

The backwards movement (along the axis XX′, in the direction represented by the arrow F) of the movable equipment 5, 70 during opening of the contacts compresses the gas present inside the compression chamber 8. The rising pressure becomes great enough to open a valve 81, which enables the gas under pressure to enter the compartment 7 through a duct 73 that passes through the wall 71; the gas in the column 8 is thus heated by the electric arc being produced as a result of the contacts 4, 5, opening and this leads to an increase in pressure. When the current passes through zero, the gas is forced out via the channel 700 in order to extinguish the electric arc. During an opening operation of the circuit breaker, gas is transferred from the compression volume 8 towards the thermal volume 7.

In addition, on its face facing the volume 8, the wall 9 including a valve 81a that acts when the pressure inside the volume 8 increases during the opening operation to close a duct 74, which duct passes through the wall 9. This valve opens in order to enable the volume 8 to be filled with gas during a closing operation. The second face of the piston 9 includes a valve 82 that is movable in translation along XX′ and that opens only when the pressure inside the volume 8 exceeds a certain value. Pressure is limited by a spring 150 that bears against one of the faces of the valve and against a shoulder 151 formed on the stationary portion.

By way of example, a third chamber 15 secured to the stationary portion 4 is disposed behind the compression volume 8. This third chamber may be disposed inside the volume defined by the inside surface of the side wall of the movable equipment 70. This side wall defines a limit beyond which the chamber 15 cannot extend.

Going from the compartment 7 along the axis XX′ in a direction opposite to that of the movable arcing contact (i.e. moving away therefrom), there can be found in succession: the compression chamber 8 followed by the third chamber 15.

This chamber 15 is defined by the stationary wall 9, and by one or more movable walls 70, 70a, 70b, 70c. The stationary wall 9 is mechanically connected, via a base 90, to the elements 110, 10, 120, and 3 of the stationary portion.

This chamber 15 may be filled with liquid. By way of example, it is fed, preferably permanently, by an external tank 30. Said tank is shown near the wall 70, but may be disposed at any other location and be connected to the compartment 15 by a suitable duct 31.

In order to avoid the liquid moving back up into the tank 30, said duct 31 is preferably provided with a check valve, preferably located inside the chamber 15 at the connection with the duct 31, enabling the liquid in the tank 30 to be transferred only towards the volume 15.

A piston 14 closes the volume 15 by being secured to the movable contact 5 and to the movable equipment 70, e.g. by means of a rigid tube or of a support column 17. The tube or column includes, or contains, an injection duct or tube 19 making it possible to put the volume of liquid 15 into communication with the thermal volume 7.

In parallel to the opening operation, and to the compression of gas contained in the volume 8, as described above, the piston 14, which is also movable, moves inside the chamber 15 in order to compress the liquid contained therein.

Under the action of this piston 14, the liquid is evacuated via the injection duct 19 by force towards the thermal volume 7. In order to avoid any gas returning from the volume 7 to the volume 15, the injection channel 19 is preferably provided with a check valve 21 only allowing the liquid in the volume 15 to pass to the thermal volume 7.

Consequently, during opening of the contacts 4, 5 some liquid is projected from the chamber 15 towards the volume 7.

In a variant, liquid may be injected, not directly into the volume 7, but firstly into the volume 8. However, that solution is less effective than a direct projection from the chamber 15 towards the volume 7.

When an electric arc is present, the assembly constituted by gas, contained in the thermal volume 7, together with the liquid that was injected therein by means of the above-described mechanism, increases in pressure under the effect of a rise in temperature. The temperature of the arc plasma becomes great enough for the liquid contained in the volume 7 to vaporize. Thus, a small amount of liquid turns into gas, significantly increasing the pressure inside the thermal volume 7. A mixture comprising the carrier gas plus a near-majority of the liquid in its gaseous form is thus obtained inside the thermal volume 7. The advantage of this mixture is that it has dielectric properties as well as arc-extinguishing properties that are better than the properties of the carrier gas. In addition, a portion of the energy of the arc is used to cause the liquid to change phase, thus cooling the arc column.

When the current crosses zero, the arc extinguishes, and the residual plasma is cooler than if there were no injection of liquid, the flow of gas is greater and its dielectric strength is improved thereby making it easier to withstand the transient recovery voltage and interrupting the short-circuit current.

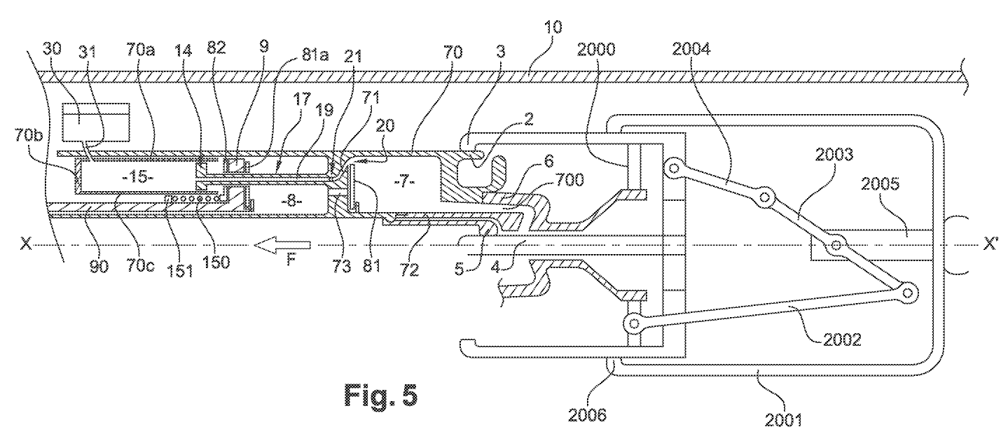

An embodiment of the invention, in the context of a double motion-type chamber, is shown in FIG. 5. The contact 3 is then also movable and may constitute a movable tube.

The differences relative to the single-movement chamber are as follows.

Means, e.g. a set of connecting rods, in this example making it possible during an opening operation of the contacts to move the contact 5 along arrow F and, also, at the same time, to move the contact 4 in a direction opposite to F.

The contact shaft 4 is connected to the movable contact 3 that slides inside a stationary tube 2001 and a contact 2006 passes current between the contact 3 and the tube 2001.

The nozzle 6 comprises a wall 2000, e.g. connected to one end of the nozzle 6. This wall 2000 slides inside the contact 3. The tube 2001 includes a support 2005 that is also stationary. A set of connecting rods 2002, 2003, 2004 connects the tube 2001 to the tube 3 by passing through a stationary point of the support 2005. By way of example, said support supports a rod 2003 that is free to rotate about a rotation axis that is perpendicular to XX′. The connecting rod 2002 is connected firstly to the nozzle 6 and secondly to the connecting rod 2003. The connecting rod 2004 connects the tube 3 to the rod 2003. During the opening operation, movement of the connecting rod 2002 along the arrow F causes the connecting rod 2003 to turn clockwise, causing the tube 3 to move in the opposite direction to F by means of the connecting rod 2004. All other above-described aspects, in combination with FIG. 1, and in particular those concerning the functions and operation of the various chambers 7, 8, 15, may be applied to this double-motion embodiment.

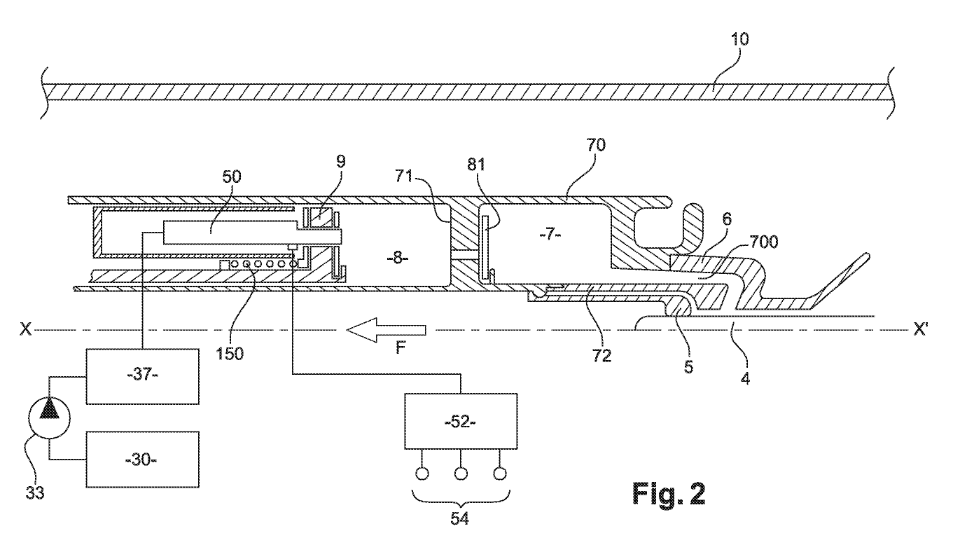

Another embodiment is shown in FIG. 2.

In this figure, as in the following figures, numerical references identical to those used in the preceding figure designate identical or similar elements.

In this embodiment, an injector 50, e.g. of the type that is used for injecting gasoline into engines, is fastened on the stationary portion 9.

By way of example, it seems that an injector having the characteristics given below may be suitable for implementing this embodiment:
reaction time of the injector of the order of 5 milliseconds (ms) to 15 ms;
liquid injection instant of the order of 5 ms to 20 ms; and
volume of injected liquid of less than 10 mL.

The fastening of the injector to the portion 9 is given by way of example. Other positions for the injector may be envisaged, again on a stationary portion, but with a connection via a tube between the outlet of the injector and the portion 9.

A tank 30 contains the liquid to be injected. The liquid is put under pressure by means of a high-pressure pump 33 and is stored in an accumulator 37 that feeds the injector 50.

In this figure, as in the following figures, the elements 30, 33, 37, 52 are shown diagrammatically for reasons of comprehension. The elements 30, 33, 35, 52 may for example be grouped together at the base of the equipment, in a grounding zone.

Finally, a device such as a computer 52, makes it possible to produce commands as a function of information coming for example from sensors 54 positioned in the device; by way of example this information relates to the relative position of the contacts 4, 5, and/or at least one current value, and/or at least one voltage value in the breaking chamber.

During opening of the circuit breaker, the computer 52 detects opening, e.g. by means of information relating to the relative position of the contacts 4, 5, and/or the value of a current and/or of a voltage. The computer is programmed to deliver an instruction to the injector 50 so that it sends a limited amount of liquid into the compression volume 8.

By way of example, the injector is controlled by means of a solenoid valve. This amount of liquid in the form of fine droplets is mixed with the gas contained inside the compression volume 8 and transferred to the thermal volume 7, when the pressure inside the compression volume is great enough to open the valve 81.

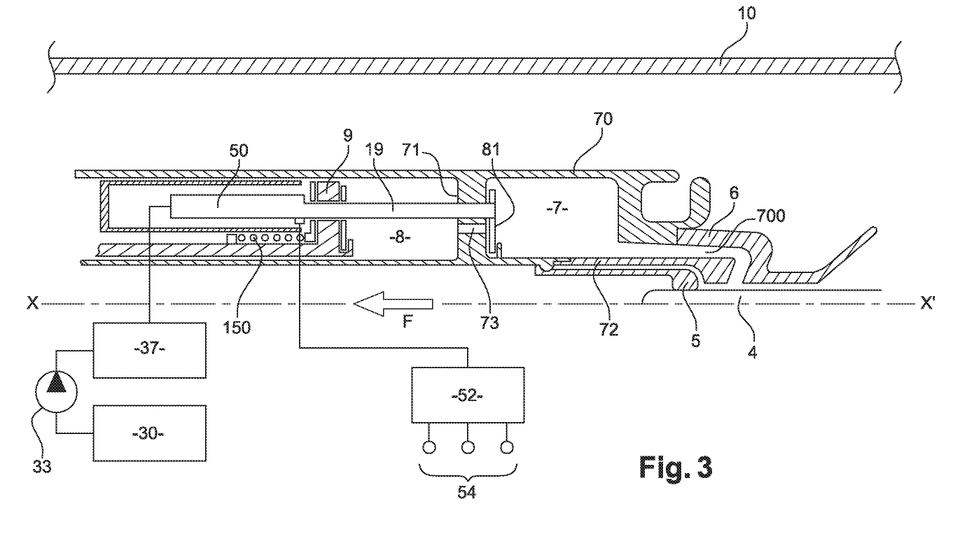

In a variant (FIG. 3), the injector is always mounted on the stationary portion 9 but it is extended by a sliding tube 19 that passes through the vertical wall 71 of the movable tube in order to thus enable liquid to be injected directly into the thermal volume 7.

In FIGS. 2 and 3, the injector 50 may include a solenoid valve for releasing the liquid into the chamber 7 or 8.

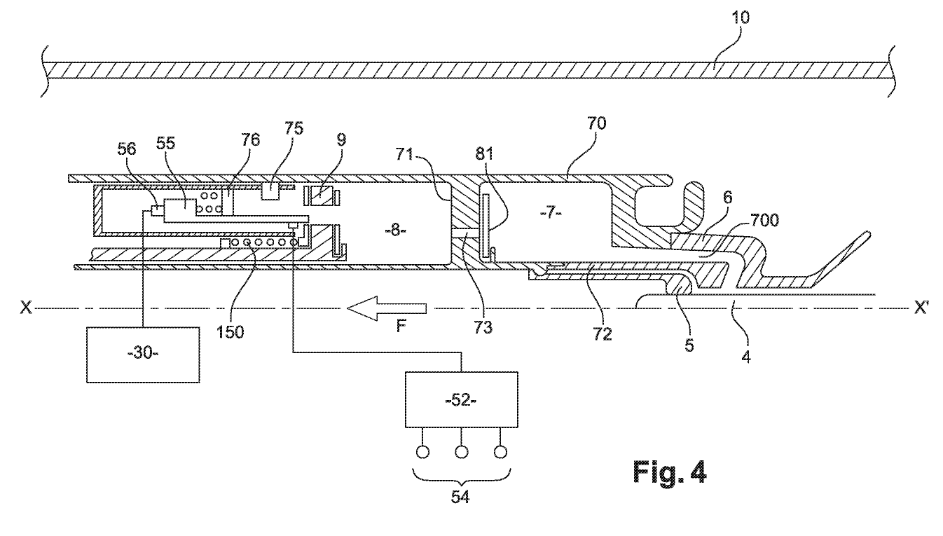

A third embodiment is shown in FIG. 4 and also implements one or more injectors 55, but they are injectors of the “pump-injector” type. This type of injector makes it possible to create the high injection pressure in independent manner. Use of a pump 33 and an accumulator 37 may thus be avoided.

In this embodiment, the injector 55 may also be fitted with a solenoid valve 56 in order to better adjust the amount of liquid injected and the instant at which liquid is injected.

The injection instant and/or the amount of liquid that is injected may be determined by the computer 52. It may take information, e.g. via sensors 54 disposed on the circuit breaker and the measurement voltage reducers. The computer 52 may send an injection command to the injector 50 or to the solenoid valve 56.

Again in this embodiment, the side wall of the movable equipment 70 (or of the wall 70a) may be provided with a pin 75. During opening of the circuit breaker, the pin 75 co-operates with means or a mechanism 76 forming a pusher in order to generate high pressure inside the injector 55; e.g. the pin 75 bears against the means or mechanism 76. This action causes the pressure of the liquid contained in the injector 55 to rise and causes it to be evacuated into the thermal volume 7 (if the assembly is provided with a tube such as the tube 19) or otherwise into the compression volume 8 (as in FIG. 4); consequently, the means 75, 76 cause the pressure in the injector 55 to rise during the backward movement of the movable equipment 70.

In an embodiment, for a pump-injector, the element 76 is secured to the injector and the element 75 of the movable portion. The element 76 is connected to a piston that generates the high pressure. The computer 52 controls opening of the valve that makes it possible for the liquid under high pressure to escape into the volume 7 or 8.

These embodiments described above in connection with FIGS. 2 to 4 may be applied both to the structure of FIG. 1 and to the structure of FIG. 5.

In the embodiments shown in FIGS. 2 to 4, the injector 50, 55 is positioned on a stationary portion 9 of the device, within the limit imposed by the side wall of the movable equipment 70, or on the inside side of said wall. It makes it possible to inject liquid into the compression chamber 8 (as in FIGS. 2 and 4), or directly into the thermal volume 7 (as in FIG. 3). The injector is advantageously disposed in the extension of the chambers 7 and 8. The injector may be activated either by means 52 such as a computer and/or by using means fastened on the movable equipment 70.

In the examples described in connection with FIGS. 2 to 4, going from the compartment 7 along the axis XX′ in a direction opposite to that of the movable arcing contact (i.e. moving away therefrom), there can be found in succession: the compression chamber 8 followed by the injector-forming means 50.

The material used in the liquid for injecting comprises at least one fluorinated compound that is advantageously selected from the group constituted by fluoronitriles, fluorinated oxiranes, fluoroketones, and mixtures thereof.

In particular, the injected fluorinated compound is a fluoronitrile and in particular a fluoronitrile satisfying the general formula (I):

R¹—C(CN) (R²)—R³ (I)

as defined above.

Advantageously, a fluoronitrile used in the context of the invention is a perfluorinated fluoronitrile having the general formula (I). In particular, for such a fluoronitrile, the group R² represents a fluorine atom.

Still more particularly, for such a fluoronitrile, the groups R¹ and R³ are different.

Advantageously, the group R¹ is a perfluoromethyl and the group R³ comprises at least 2 carbon atoms. Thus, the fluoronitriles for use in the present invention have the formulas C₄F₉CN, C₅F₁₁CN, C₆F₁₅CN, and C₇F₁₅CN. It is possible to use isomers of any conceivable constitution for the group R³. More particular examples of fluoronitriles suitable for use in the present invention have any one of the semi-structural chemical formulas below:

C₄F₉CN C₅F₁₁CN C₆F₁₃CN C₇F₁₅CN

What is claimed is:

1-19. (canceled)

20. A breaking chamber for a medium- or high-voltage circuit breaker extending along a longitudinal axis (XX′) and comprising:
a pair of arcing contacts, at least one of which is movable along the longitudinal axis (XX′) under the action of a drive member, the contacts separating when current is interrupted;
an arc-blast nozzle that is secured to the stationary arcing contact;
a first chamber, referred to as a “blast” chamber, having a volume (V2) that is constant and that opens out inside the blast nozzle;
a second chamber, referred to as a “compression” chamber, arranged substantially behind the blast chamber, parallel to the longitudinal axis (XX′), and means for putting the internal volume of said compression chamber into communication with the blast chamber; and
means, disposed substantially behind the compression chamber, parallel to the longitudinal axis (XX′), in order to deliver liquid, either to the compression chamber, or directly to the blast chamber.

21. A breaking chamber according to claim 20, the means disposed substantially behind the compression chamber in order to deliver liquid, either to the compression chamber, or directly to the blast chamber, comprising a third chamber and a piston that is able to move inside said third chamber under the action of a backwards movement of the movable equipment of said chamber.

22. A breaking chamber according to claim 21, further comprising a channel for injecting a liquid present in said third chamber into the blast chamber.

23. A breaking chamber according to claim 22, said channel further comprising a check valve.

24. A breaking chamber according to claim 20, wherein the means that are disposed substantially behind the compression chamber in order to deliver liquid, either to the compression chamber, or directly to the blast chamber, include a liquid injector.

25. A breaking chamber according to claim 24, further comprising a calculator controlling said liquid injector.

26. A breaking chamber according to claim 25, said calculator being connected to at least one sensor.

27. A breaking chamber according to claim 26, said at least one sensor comprising at least one sensor for sensing the relative position of the contacts, and/or a sensor for measuring a current value, and/or a sensor for measuring voltage in said chamber.

28. A breaking chamber according to claim 24, the movable equipment further comprising means for activating a rise in pressure in said liquid injector.

29. A breaking chamber according to claim 24, further comprising a liquid accumulator in order to feed said liquid injector.

30. A breaking chamber according to claim 29, further comprising a liquid storage storing liquid for feeding said liquid accumulator.

31. A breaking chamber according to claim 24, said a liquid injector forming at least one pump-injector.

32. A breaking chamber according to claim 31, said at least one pump-injector being fed by a tank, to which it is connected without using an accumulator or a pump.

33. A breaking chamber according to claim 31, further comprising an activator of said pump-injector.

34. A breaking chamber according to claim 20, each contact of the pair of arcing contacts being movable along the longitudinal axis (XX′).

35. A breaking chamber according to claim 20, wherein said liquid comprises at least one fluorinated compound selected from the group constituted by fluoronitriles, fluorinated oxiranes, fluoroketones, and mixtures thereof.

36. A breaking chamber according to claim 20, wherein the filling gas comprises or is air and/or nitrogen, and/or oxygen, and/or carbon dioxide, and/or an inert gas, and/or a fluoronitrile, and/or a fluorinated oxirane, and/or a fluoroketone.

37. A breaking chamber according to claim 36, 2,3,3,3-tetrafluoro-2-trifluoromethyl propanenitrile or heptafluoroisobutyronitrile having the formula CF₃—C(CN)(F)—CF₃ and the CAS number: 42532-60-5 being added to the filling gas.

38. A method of operating a breaking chamber according to claim 20, wherein said liquid is injected, either into the compression chamber, or directly into the blast chamber, during separation of the arcing contacts.

39. A breaking chamber for a medium- or high-voltage circuit breaker extending along a longitudinal axis (XX′) and comprising:
a pair of arcing contacts, at least one (5) of which is movable along the longitudinal axis (XX′) under the action of a drive member, the contacts separating when current is interrupted;
an arc-blast nozzle that is secured to the stationary arcing contact;
a first chamber, referred to as a “blast” chamber, having a volume V2 that is constant and that opens out inside the blast nozzle;
a second chamber, referred to as a “compression” chamber, arranged substantially behind the blast chamber, parallel to the longitudinal axis (XX′), and means for putting the internal volume of said compression chamber into communication with the blast chamber; and
a liquid injector, or a third chamber and a piston that is able to move inside said third chamber under the action of a backwards movement of the movable equipment of said chamber, said liquid injector or said third chamber being disposed substantially behind the compression chamber, parallel to the longitudinal axis (XX′), in order to deliver liquid, either to the compression chamber, or directly to the blast chamber.
